(19) United States
(12) Patent Application Publication
(10) Pub. No.: US 2018/0339648 A1
(43) Pub. Date: Nov. 29, 2018

(54) VEHICLE SILL ILLUMINATION ASSEMBLY AND ASSOCIATED SENSOR SYSTEM

(71) Applicant: Steven G. Hoek, Holland, MI (US)

(72) Inventor: Steven G. Hoek, Holland, MI (US)

(21) Appl. No.: 15/986,024

(22) Filed: May 22, 2018

Related U.S. Application Data
(60) Provisional application No. 62/509,782, filed on May 23, 2017.

(51) Int. Cl. B60Q 3/217; B60Q 3/80; H05B 37/02

(52) U.S. Cl. CPC B60Q 3/217; F21W 2106/00; H05B 37/0227; B60Q 3/80

(57) ABSTRACT

A vehicle sill illumination assembly adapted for use with a vehicle, including an energy source, a vehicle door sensor having a magnet and a Hall effect switch, a light source controller, a light source current driver, and a light source. The vehicle sill illumination assembly does not require an external energy source and/or be connected to the vehicle's electrical system.

### CROSS-REFERENCE TO RELATED APPLICATIONS

This application claims the benefit of U.S. Provisional Patent Application Ser. No. 62/509,782, filed May 23, 2017, entitled “Sensor System For Illuminated Kick Plate”—which is hereby incorporated herein by reference in its entirety, including all references and appendices cited therein.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to vehicle sill illumination assemblies and associated sensor systems and, more particularly, to vehicle sill illumination assemblies that do not require an external energy source and/or be connected to the vehicle's electrical system. The sensor system of the present invention preferably utilizes a Hall effect sensor that automatically turns on a light source (e.g., a light-emitting diode (LED)) which results in, for example, an illuminated emblem, logo, branding icon or some other aesthetic feature that is located proximate to and/or in the door jamb of the vehicle. The sensor system detects when the vehicle's door is in an open state or a closed state. When the vehicle's door is in an open state, then the light source associated with the vehicle sill illumination assembly is on, and when the vehicle's door is in a closed state, then the light source associated with the vehicle sill illumination assembly is off.

### 2. Background Art

Illuminated kick plates associated with vehicles have been known in the art for years and are the subject of a plurality of patents and publications, including: U.S. Pat. No. 9,862,309 entitled “Vehicle Sill Illumination Assembly,” U.S. Pat. No. 9,812,042 entitled “Lighted Trim Assembly and Perforated Member Therefor,” U.S. Pat. No. 8,007,148 entitled “Vehicular Illumination Device,” U.S. Pat. No. 7,556,412 entitled “Fiber Optic Auxiliary Lighting System,” U.S. Pat. No. 5,915,830 entitled “Light-Tube Running Board Lighting,” U.S. Pat. No. 5,430,627 entitled “Step Lighting Apparatus,” U.S. Pat. No. 4,557,494 entitled “Running Board,” U.S. Pat. No. 4,544,991 entitled “Lighted Running Board,” U.S. Pat. No. 4,463,962 entitled “Running Board and Lighting Assembly,” and U.S. Pat. No. 2,081,899 entitled “Automobile Running Board,”—all of which are hereby incorporated herein by reference in their entirety including all references cited therein.

U.S. Pat. No. 9,862,309 appears to disclose a vehicle sill illumination assembly that has a main body, an illumination panel and a controller. The main body includes a first portion, a second portion and a third portion that together define an inverted U-shaped structure as viewed in cross-section. The first portion has an upright surface. The second portion extends horizontally inboard from an upper edge of the first section. The third portion extends downward from an inboard side of the second portion. The illumination panel is installed to an area of the first portion of the main body such that the illumination panel faces in an outboard direction with the main body installed to a vehicle sill structure. The controller is located within the main body and is configured to control illumination of the illumination panel.

U.S. Pat. No. 9,812,042 appears to disclose a lighted assembly that includes a perforated member having a plurality of relatively small openings therethrough. The openings are arranged to provide areas forming letters, designs, or the like. A light source may be positioned adjacent the perforated member whereby light from the light source travels through the openings to form illuminated letters, designs or the like. The perforations may be filled with a light-transmitting polymer material. The light source may comprise an LED and a light guide that distributes light along a lower side of the perforated member. The light source may be positioned in a waterproof housing that is sealed to the perforated member.

U.S. Pat. No. 8,007,148 appears to disclose a vehicular illumination device which illuminates a lower part around an opened part of a door at a side of a vehicle, a side sill garnish is provided below the door-opened part, and a lamp and a lamp garnish which retains the lamp are arranged on a lower face of the side sill garnish. As the lamp is retained by the lamp garnish, the lamp can efficiently and appropriately illuminate an underfoot floor when a person rides on and off the vehicle. Moreover, the lamp garnish has a recess, and an edge which is provided around an opened part of the recess. As the lamp is arranged in the recess, the lamp is not visually recognized directly from the exterior of edge parts, thereby preventing a following vehicle from falsely recognizing the lamp as a backup lamp.

U.S. Pat. No. 7,556,412 appears to disclose a lighting device that includes a housing containing a light emitting portion of a light emitting diode and a terminus of a fiber optic bundle such that light emission from the light emitting diode is communicated along the optical fibers. The fiber optic bundle has a flattened distal portion with a cross-sectional array of layers of optical fibers. A diffusing layer is attached to the fiber optic bundle overlying the flattened distal portion. The lighting device, upon being overlaid with a graphic and surrounded by a frame through which the graphic is visible, provides a vehicle lighting assembly securable to a vehicle substrate. The vehicle light assembly is particularly well suited for vehicle exterior badging, kick plates and vanity lighting within the vehicle passenger compartment.

U.S. Pat. No. 5,915,830 appears to disclose a running board light assembly having a light source emitting light into a light tube extending along the length of a running board. The light tube casts light directly and uniformly upon a stepping surface of the running board and upon a ground surface below the running board, without directing excessive glare or light into the eyes of the user.

U.S. Pat. No. 5,430,627 appears to disclose a light fixture housing extrusion that includes a horizontal step plate intersecting a vertical riser plate and having first and second channels for mounting string light fixtures beneath removable translucent covers, the channels including grooved wall structures to facilitate securing of the covers and either a pair of tangs or a pair of interior recessed walls for receiving and retaining a spring-biased wedge clip lamp carriage. Other features include an improved wiring scheme with individually-fused light strings, a diode for dimming the light output of selected strings, and a riser lens cover having a unitarily-extruded extended shield which prevents viewing the direct glare from elevated lighting fixtures.

U.S. Pat. No. 4,557,494 appears to disclose a running board having a series of lighting elements disposed within an enclosed cavity along the outer edge of the running board, and a mounting structure including a channel on the underside of the running board deck, which channel supports a fastener and secures the fastener against rotation by the mating engagement of a channel rib with a slot in the head of the fastener.

U.S. Pat. No. 4,544,991 appears to disclose a lighted running board for vehicles including a deck, a kick plate and a rib. The kick flange and rib include openings in which lights are positioned, the lights including clips for securement within the openings. A rear cover member attached to the inner face of the kick plate and rib houses and protects the electrical connections between the lights and the power source.

U.S. Pat. No. 4,463,962 appears to disclose a running board and lighting assembly for mounting to a vehicle and in which the running board includes a deck and an elongated plate extending angularly from an edge of the deck. A pair of inwardly turned flanges are formed integrally with the plate extending longitudinally of the deck and parallel thereto to form a channel at the edge of the plate adjacent the deck to slidably receive a light strip or other slidable element.

U.S. Pat. No. 2,081,899 appears to disclose an illuminated running board for automobiles adapted to cast beams of light on the road beside the automobile. The illuminated running board can be substituted for the conventional automobile running board without altering the construction of the automobile. The illuminated running board for automobiles is not only adapted to cast in beams of light to the roadside of automobiles, but can also be reversed to cast beams of light beneath the automobile when working under the same.

While vehicle sill illumination assemblies and associated components, as disclosed hereinabove, have been known in the art for years, issues associated with illumination longevity when not connected to the vehicle's electrical system remain problematic and/or unresolved. As such, there remains a genuine demand for vehicle sill illumination assemblies and associated sensor systems that do not require an external energy source and/or be connected to the vehicle's electrical system. Such illumination assemblies are particularly advantageous for port installation, dealer installation, and/or any post production or aftermarket installation.

These and other objects of the present invention will become apparent in light of the present specification, claims, and drawings.

### SUMMARY OF THE INVENTION

The present invention is directed to a vehicle sill illumination assembly adapted for use with a vehicle, comprising, consisting essentially of, and/or consisting of: (a) an energy source, wherein the energy source is associated with the vehicle sill (a/k/a the vehicle rocker panel and/or kick plate associated with the same); (b) a vehicle door sensor, wherein the vehicle door sensor is associated with the vehicle sill; (c) a light source controller, wherein the light source controller is associated with the vehicle sill; (d) a light source current driver, wherein the light source current driver is associated with the vehicle sill; and (e) a light source, wherein the light source is associated with the vehicle sill.

In a preferred embodiment of the present invention, the vehicle sill illumination assembly is void of electrical communication with an electrical system of the vehicle.

In another preferred embodiment of the present invention, the vehicle sill illumination assembly is void of electrical communication with an external energy source.

In yet another preferred embodiment of the present invention, the energy source comprises a primary electrochemical cell and/or a secondary electrochemical cell.

In another aspect of the present invention, the energy source comprises a plurality of lithium electrochemical coin cells preferably connected in parallel.

In a preferred embodiment of the present invention, the vehicle door sensor comprises a transducer that varies its output voltage in response to a change in magnetic field, and a magnet.

In another preferred embodiment of the present invention, the vehicle door sensor comprises a Hall effect switch and a magnet. In this embodiment, the Hall effect switch changes state based upon a reduction in the strength of the magnetic field when the vehicle door is closed.

In yet another preferred embodiment of the present invention, the light source controller comprises a timer and/or a microprocessor.

In another aspect of the present invention, the light source current driver preferably regulates voltage and/or current to the light source. In this embodiment, such regulation preferably occurs via mono-directional electrical communication.

In a preferred embodiment of the present invention, the light source comprises at least one of a light-emitting diode, an organic light-emitting diode, a tri-color (RGB) light-emitting diode, an incandescent bulb, a tungsten-halogen bulb, a xenon bulb, a fluorescent bulb, a compact fluorescent lamp, a high-intensity discharge bulb, and/or an electroconductive, lightable paint/material.

In another preferred embodiment of the present invention, the vehicle sill illumination assembly further comprises a light guide positioned adjacent to the light source.

In yet another preferred embodiment of the present invention, the vehicle sill illumination assembly further comprises a diffuser, a lens, and/or a brightness enhancing film positioned adjacent to the light guide.

In a preferred embodiment of the present invention, the energy source is in electrical communication with the vehicle door sensor.

In another preferred embodiment of the present invention, the vehicle door sensor is in electrical communication with the energy source and the light source controller.

In yet another preferred embodiment of the present invention, the light source controller is in electrical communication with the vehicle door sensor and the light source current driver.

In another aspect of the present invention, the light source current driver is in electrical communication with the vehicle door sensor, the light source controller, and the light source.

In a preferred embodiment of the present invention, the light source current driver is in exclusive, mono-directional electrical communication with the light source.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 of the drawings is a schematic representation of components of the sensor system and vehicle sill illumination assembly for use in accordance with the present invention;

FIG. 2 of the drawings is a side view of a representative vehicle;

FIG. 3 of the drawings is a fragmented isometric view of the door jamb/sill of the vehicle of FIG. 2 taken along line A-A;

FIG. 4 of the drawings is a sectional view of the door jamb/sill of the vehicle of FIG. 2 taken along line A-A;

FIG. 5 of the drawings is a fragmented isometric view of a vehicle sill illumination assembly manufactured in accordance with the present invention;

FIG. 6 of the drawings is a fragmented sectional view of a sill illumination assembly manufactured in accordance with the present invention;

FIG. 7 of the drawings is a sectional view of a sensor system of the vehicle sill illumination assembly when the vehicle door is open. This figure further includes magnetic field graphical representations; and

FIG. 8 of the drawings is a sectional view of a sensor system of the vehicle sill illumination assembly when the vehicle door is closed. This figure further includes magnetic field graphical representations.

### DETAILED DESCRIPTION OF THE INVENTION

While this invention is susceptible of embodiment in many different forms, there is disclosed and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

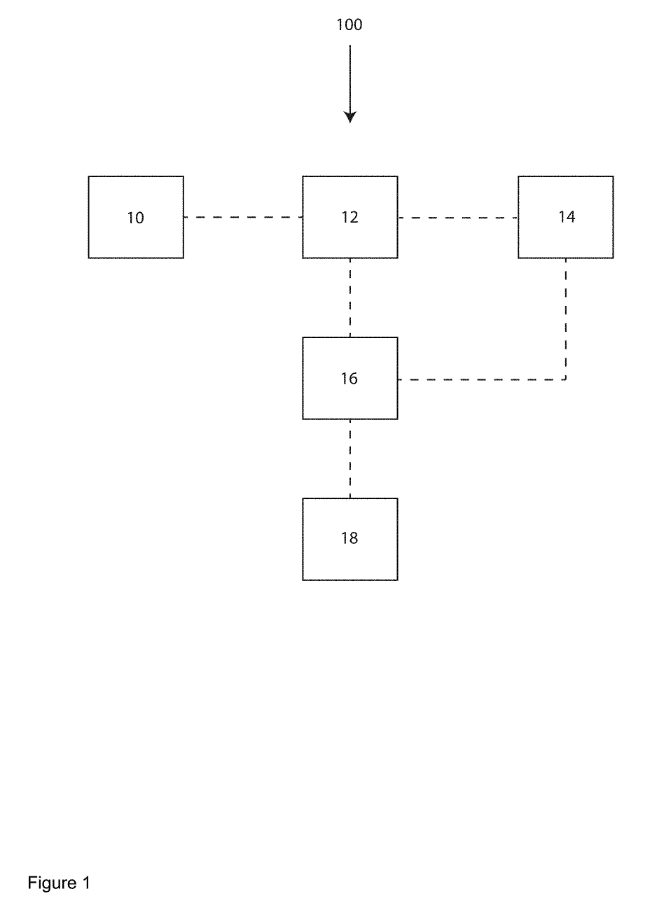

Referring now to the drawings and, more particularly, to FIG. 1, vehicle sill illumination assembly 100 is schematically shown as generally comprising energy source 10, vehicle door sensor 12, light source controller 14, light source current driver 16, and light source 18. Notably, vehicle sill illumination assembly 100 is operable for years even without an external energy source and it does not require any connection to the vehicle's electrical system.

While illumination assembly 100 has been disclosed as being associated with a vehicle sill, it is likewise contemplated that illumination assembly 100 may also be associated with a vehicle rocker panel, a vehicle kick plate, a vehicle door (particularly the bottom panel), a vehicle door jamb, a vehicle trunk, a vehicle hood, areas proximate to the above-identified vehicle areas/parts, etcetera.

Energy source 10 provides energy directly to vehicle door sensor 12. Energy source 10 also provides energy indirectly to light source 18 via light source controller 14 and light source current driver 16. Preferably, energy source 10 comprises a primary electrochemical cell and/or a secondary electrochemical cell.

In one embodiment of the present invention, energy source 10 preferably comprises a secondary electrochemical cell, such as a lead acid, NiCad, NiMH, and/or lithium-ion battery. Preferred examples of lithium-ion batteries include lithium cobalt oxide (LiCoO₂) batteries, lithium manganese oxide (LiMn₂O₄) batteries, lithium nickel manganese cobalt oxide (LiNiMnCoO₂) batteries, lithium iron phosphate (LiFePO) batteries, lithium nickel cobalt aluminum oxide (LiNiCoAlO₂) batteries, and lithium titanate (Li₄Ti₅O₁₂) batteries. In one embodiment each battery comprises an anode, a cathode, and an electrolyte, wherein at least one of the anode, cathode, and electrolyte are monitored for degradation and/or structural integrity of the anode, the cathode, and/or the electrolyte, and/or the cycle life of each component—including electrolyte level. In another embodiment of the present invention, energy source 10 comprises a plurality (e.g., 1, 2, 3, 4, 5, 6, 7, 8, 9, 10, etcetera) of lithium electrochemical coin cells that are connected in parallel to achieve a predetermined output voltage and capacity.

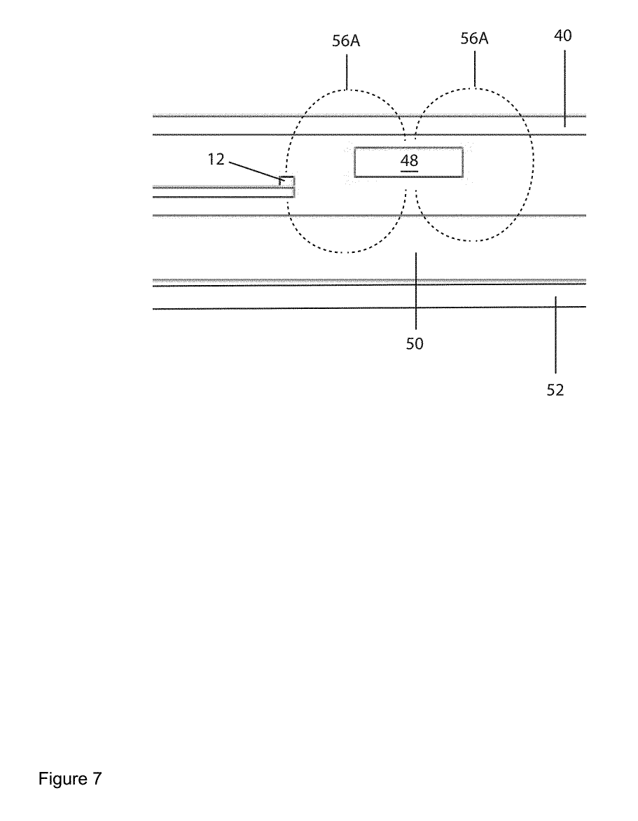

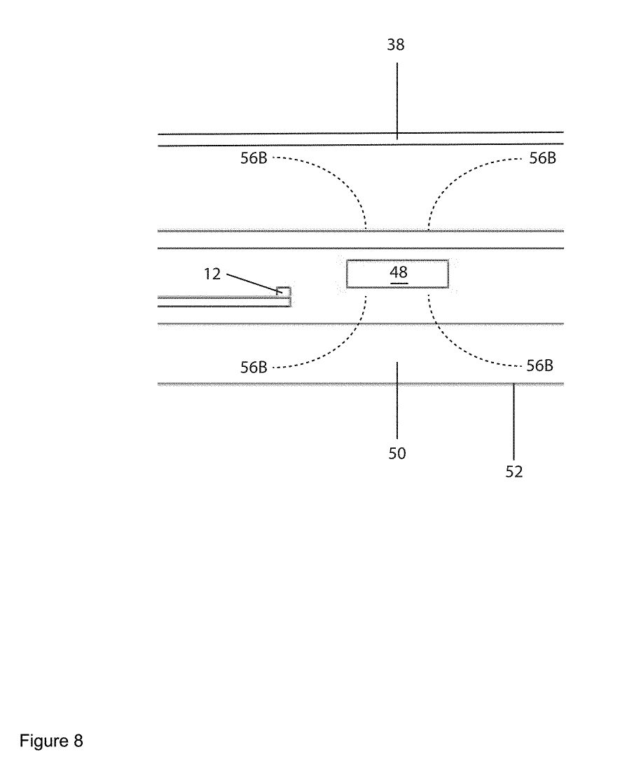

Vehicle door sensor 12 preferably comprises a transducer, such as a Hall effect sensor/switch and a magnet. In this embodiment, the Hall effect switch preferably changes state based upon a reduction in the strength of the magnetic field when the vehicle door is closed. Preferably, the Hall effect switch monitors the magnetic field created by the door sill's and/or kick plate's integrated magnet. The other elements of the circuit are preferably isolated and/or in a zero potential or “dark state” when the magnetic field is below a predetermined threshold level. When the magnetic field on this switch increases above the threshold level, then light source controller 14, and, in turn, light source current driver 16, become active. Suitable components for vehicle door sensor 12 include part numbers A1171 and A3211 from Allegro Microsystems. Preferred sensor materials include gallium arsenide, indium arsenide, indium phosphide, indium antimonide, and graphene—just to name a few. Additional details regarding the configuration of vehicle door sensor 12 will be discussed below with reference to FIGS. 7 and 8.

Light source controller 14 preferably comprises a timer and/or microprocessor. Light source controller 14 serves primarily as a timing device to limit the amount of drain on energy source 10. Light source controller 14 will turn off light source 18 after a set time threshold. This is to prevent the light source from being on continuously if the vehicle door is left open for an extended period of time. It is expected that the light source will not typically be on for more than approximately 15-30 seconds.

Light source controller 14 secondarily and optionally functions to provide a pulse width modulation output, and, in turn, a dimming function to the light source. Light source controller 14 may also be used to monitor the voltage of energy source 10 and reduce the brightness of the light source as the batteries (i.e., energy source 10) age to extend the overall life of the system before batteries need to be replaced. In addition, light source controller 14 may also monitor a photodiode that inhibits illumination in bright daytime conditions to reduce battery consumption. In a preferred embodiment, light source controller 14, comprises a microprocessor, such as Microchip's low power ATtiny10 and/or any microprocessor having similar performance characteristics of an 8-bit AVR RISC based microcontroller. However, light source controller 14 may also comprise a timer, such as ST microsystems integrated circuit TS555.

Light source current driver 16 preferably regulates the voltage and/or current to light source 18. Light source current driver 16 can adopt/accommodate a charge pump or boost convertor. It will be understood that batteries age over time and their voltage also changes as current is drawn due to internal battery resistance. Without voltage regulation and current control, the light source will change and/or fail to turn on entirely as the battery voltage falls below the V_{f} requirement of the light source. One suitable example of light source current driver 16 includes an LED driver, such as Diodes Inc's integrated circuit ZXLD383 running, for example, in Buck-boost mode.

Light source 18 preferably comprises at least one of a light-emitting diode, an organic light-emitting diode, a tri-color (RGB) light-emitting diode, an incandescent bulb, a tungsten-halogen bulb, a xenon bulb, a fluorescent bulb, a compact fluorescent lamp, a high-intensity discharge bulb, and an electroconductive, lightable paint/material.

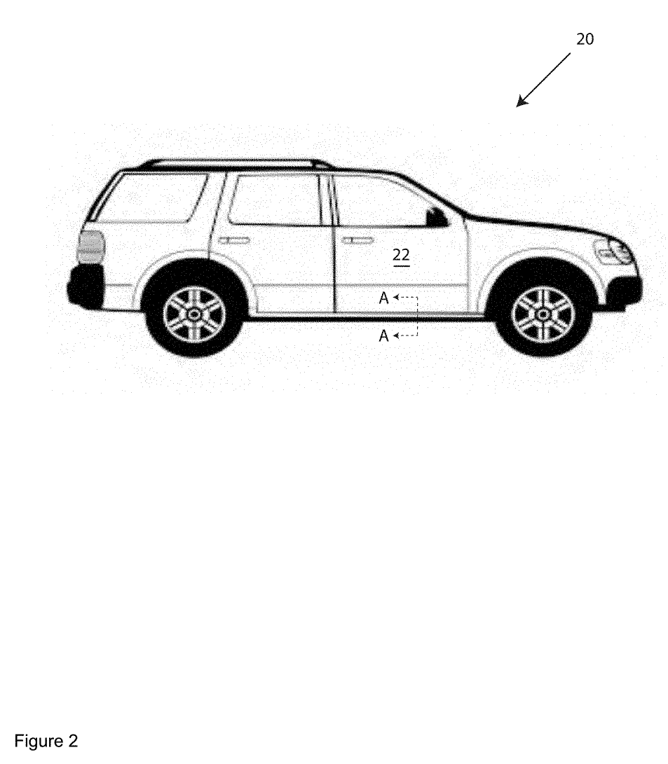

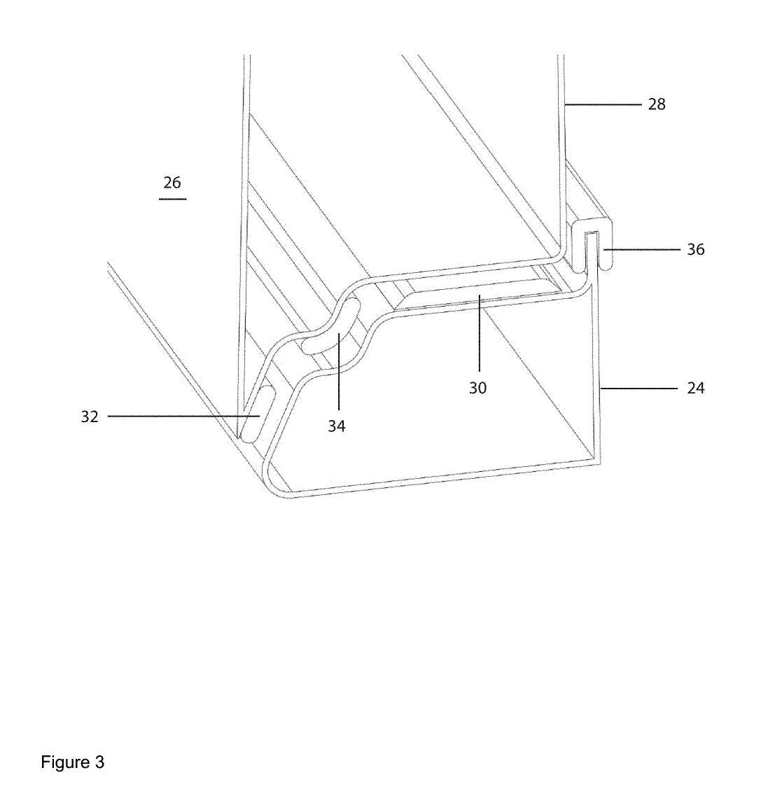

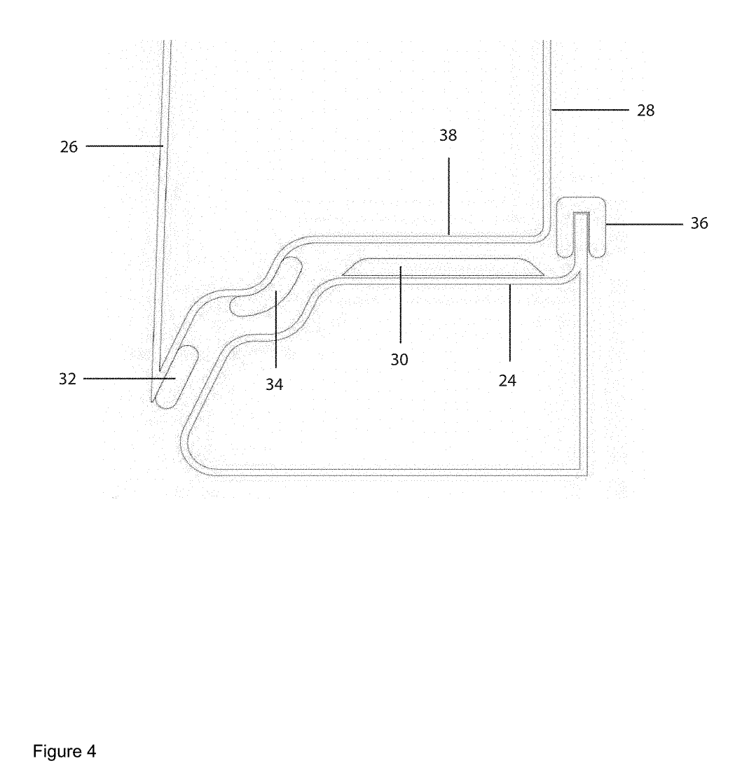

With reference to one embodiment of the present invention, and referring now to FIG. 2, the side of a representative vehicle 20 is shown. Passenger door 22 and the rocker panel are shown sectioned at location A-A. These sections are shown in FIG. 3 and FIG. 4. It is in this area of the vehicle where illumination assembly 100 is installed on the vehicle.

Referring now to FIGS. 3-4, the passenger door and rocker panel section discloses vehicle door outer sheet metal 26, vehicle door inner sheet metal 28, and rocker panel 24. The section shows the location of illuminated kick plate 30 relative to vehicle door inner sheet metal 28, vehicle door outer sheet metal 26, and rocker panel 24. Other components typically found in this area of the vehicle are shown in FIG. 4 and include outer seals 32 and 34 used to prevent the intrusion of water and wind noise into the cabin of the vehicle, and inner seal 36 which is provided for similar purposes. As is shown in FIG. 4, illuminated kick plate 30 is preferably positioned between lower door sheet metal 38 and rocker panel 24 when the door is in the “closed” position.

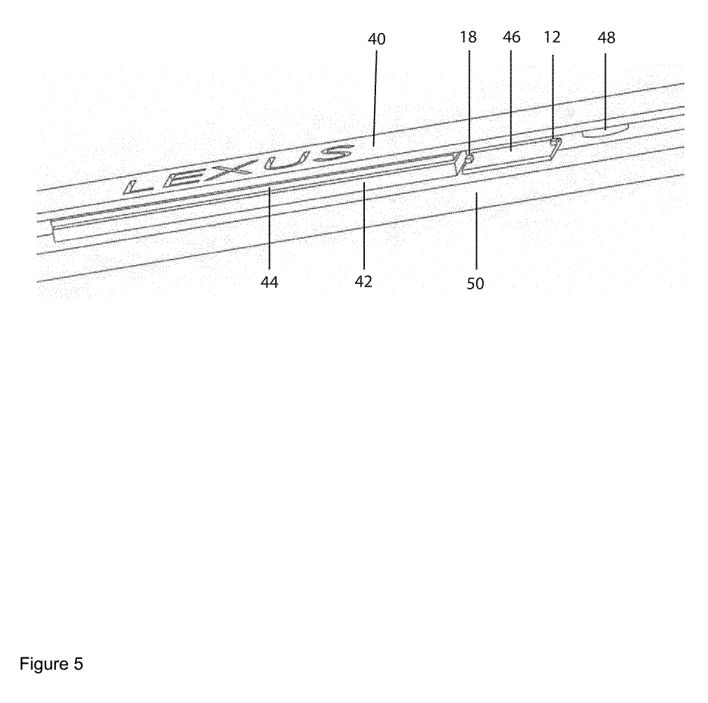

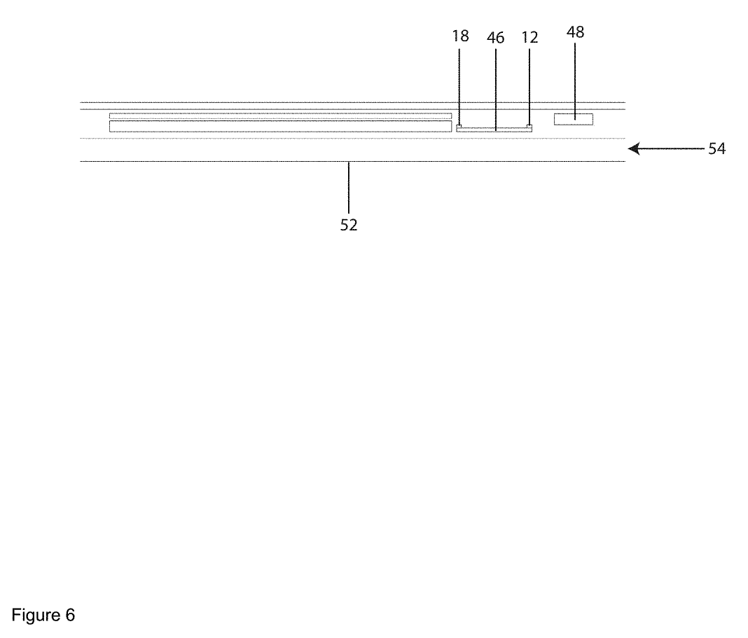

As is best shown in FIGS. 5 and 6, the illuminated kick plate may include a cosmetic surface component 40. This cosmetic surface component allows the light from light source 18, that is optionally transmitted through light guide member 42, to illuminate a brand name such as LEXUS.® The light from light source 18 may also pass through a plurality of diffusers, lenses, and/or brightness enhancing films shown categorically as item 44 before being emitted through the top surface of the illuminated kick plate. Preferably, light source 18 is associated with and/or part of a printed circuit board assembly 46 that also includes light source sensor/Hall effect switch 12. Printed circuit board assembly 46 may also contain other electronic circuitry that might be useful for the operation of the entire system. Printed circuit board assembly 46, magnet 48, and light guide member 42 are preferably contained between cosmetic surface component 40 and base plate 50. Hall effect switch 12 detects the magnetic field that is produced by magnet 48 which is contained in the illuminated kick plate. The magnet needs to be sufficiently spaced apart from rocker panel sheet metal 52. Spacing 54 depicts the separation between the magnet and the sheet metal. The spacing/dimension labeled 54 includes the thickness of base plate 50 and also air, plastic or any other material that does not significantly disrupt the magnet field radiating from bottom surface of the magnet.

Referring now to FIG. 7, magnetic field 56A is shown between the poles of magnet 48 with dashed lines. This figure depicts the magnetic field when the vehicle door is open. Notably, the magnetic field from magnet 48 passes through Hall effect switch 12 and can be easily detected by the switch. Cosmetic surface component 40 is preferably manufactured from either cosmetic plastic or stainless steel and does not significantly disrupt the magnetic field created by the magnet. Base plate 50 is preferably manufactured from plastic and also does not significantly affect the magnetic field. The distance (FIG. 6, item 54) between magnet 48 and rocker panel sheet metal 52 is large enough so that the magnetic field can be effectively detected by Hall effect switch 12. When the Hall effect switch is exposed to this magnetic field, the switch is in the closed state and the light source for the illuminated kick plate is turned on.

Referring now to FIG. 8, magnetic field 56B is shown with dashed lines. This figure depicts the magnetic field when the vehicle door is closed. When the vehicle door is closed, then magnetic field 56B created by magnet 48 is shifted away from Hall effect switch 12 by lower door sheet metal 38. The magnetic field strength is lowered below the switching threshold of the Hall effect switch, and the switch is in the open state and the light source is turned off.

The foregoing description merely explains and illustrates the invention and the invention is not limited thereto except insofar as the appended claims are so limited, as those skilled in the art who have the disclosure before them will be able to make modifications without departing from the scope of the invention.

What is claimed and desired to be secured by Letters Patent of the United States is:

1. A vehicle sill illumination assembly adapted for use with a vehicle, comprising:
an energy source, wherein the energy source is associated with the vehicle sill;
a vehicle door sensor, wherein the vehicle door sensor is associated with the vehicle sill;
a light source controller, wherein the light source controller is associated with the vehicle sill;
a light source current driver, wherein the light source current driver is associated with the vehicle sill; and
a light source, wherein the light source is associated with the vehicle sill.

2. The vehicle sill illumination assembly according to claim 1, wherein the vehicle sill illumination assembly is void of electrical communication with an electrical system of the vehicle.

3. The vehicle sill illumination assembly according to claim 1, wherein the vehicle sill illumination assembly is void of electrical communication with an external energy source.

4. The vehicle sill illumination assembly according to claim 1, wherein the energy source comprises at least one of a primary electrochemical cell and a secondary electrochemical cell.

5. The vehicle sill illumination assembly according to claim 1, wherein the energy source comprises a plurality of lithium electrochemical coin cells connected in parallel.

6. The vehicle sill illumination assembly according to claim 1, wherein the vehicle door sensor comprises a transducer and a magnet.

7. The vehicle sill illumination assembly according to claim 1, wherein the vehicle door sensor comprises a Hall effect switch and a magnet.

8. The vehicle sill illumination assembly according to claim 7, wherein the Hall effect switch changes state based upon a reduction in the strength of the magnetic field when the vehicle door is closed.

9. The vehicle sill illumination assembly according to claim 1, wherein the light source controller comprises at least one of a timer and a microprocessor.

10. The vehicle sill illumination assembly according to claim 1, wherein the light source current driver regulates at least one of voltage and current to the light source.

11. The vehicle sill illumination assembly according to claim 1, wherein the light source comprises at least one of a light-emitting diode, an organic light-emitting diode, a tri-color (RGB) light-emitting diode, an incandescent bulb, a tungsten-halogen bulb, a xenon bulb, a fluorescent bulb, a compact fluorescent lamp, a high-intensity discharge bulb, and an electroconductive, lightable paint/material.

12. The vehicle sill illumination assembly according to claim 1, wherein the light source comprises at least one light-emitting diode.

13. The vehicle sill illumination assembly according to claim 1, further comprising a light guide positioned adjacent to the light source.

14. The vehicle sill illumination assembly according to claim 13, further comprising at least one of a diffuser, a lens, a brightness enhancing film positioned adjacent to the light guide.

15. The vehicle sill illumination assembly according to claim 1, wherein the energy source is in electrical communication with the vehicle door sensor.

16. The vehicle sill illumination assembly according to claim 1, wherein the vehicle door sensor is in electrical communication with the energy source and the light source controller.

17. The vehicle sill illumination assembly according to claim 1, wherein the light source controller is in electrical communication with the vehicle door sensor and the light source current driver.

18. The vehicle sill illumination assembly according to claim 1, wherein the light source current driver is in electrical communication with the vehicle door sensor, the light source controller, and the light source.

19. The vehicle sill illumination assembly according to claim 1, wherein the light source current driver is in exclusive, mono-directional electrical communication with the light source.

20. The vehicle sill illumination assembly according to claim 1, wherein the light source is in exclusive electrical communication with the light source current driver.
